(19) United States
(12) Patent Application Publication
(10) Pub. No.: US 2003/0223603 A1
(43) Pub. Date: Dec. 4, 2003

(54) Sound space replication

(76) Inventor: Kenneth Oren Beckman, La Honda, CA (US)

Correspondence Address: ECINEMAVENTURES, POST OFFICE BOX 620106, WOODSIDE, CA, 94062, US

(21) Appl. No.: 10/428,635

(22) Filed: May 5, 2003

Related U.S. Application Data
(60) Provisional application No. 60/383,683, filed on May 28, 2002.

(51) Int. Cl. H04R 5/00; H04R 5/02

(52) U.S. Cl. 381/310; 381/18; 381/61

(57) ABSTRACT

Sound Space Replication is a multichannel audio system optimization and management system. The replication begins by mapping and storing volumetric acoustic topological data of the primary (audio creation) venue's sound system in situ, associated with the completion of an audio program material. Prior to playback, the secondary (audio listening) venue's sound system is similarly mapped in situ. The secondary data is compared to the primary data, with discrepancies articulated as corrections data. The corrections data applied to the secondary audio system include wave shaping, phase, spatial repositioning, miss-configured and phantom channel replacement, etc. The secondary audio system sound space is thus optimized as directly referenced to the primary audio system sound space. Program material utilizing Sound Space Replication provides a secondary sound space that has been objectively referenced, automatically optimized, and quantifiably congruent with the primary sound space in which the audio program material was originally approved by the director/sound-designer/creator.

### PROVISIONAL PATENT APPLICATION FILING

I claim benefit of my Provisional Patent Application Filing: Application No. 60/383,683 Dated May 28, 2002

### FIELD OF THE INVENTION

Sound Space Replication relates to audio reproduction, to include audio reproduction systems utilizing a plurality of audio channels, and providing volumetrically designed (ie. multichannel or “surround”) acoustic program material.

### BACKGROUND OF THE INVENTION

Professional audio creation venues (ie. mix-down rooms, mastering rooms, encoding rooms, etc.) are each at least slightly different from each other, regardless of the multiplicity of standards that may be applicable. Playback venues (ie. theatrical or listening/consumer environments) are qualitatively even more broadly diverse. To date, popular “Surround Sound” systems with 6 channels (5.1) have proven to be at least somewhat bewildering for most consumers. The standards body Society of Motion Picture and Television Engineers DC28.6W Digital Cinema Working Group has substantially increased the number of audio channels for Digital Cinema, currently at an upwardly mobile 16 channels. This trend toward significant increases of the number of audio channels threatens the possible collapse of the entire format, as well as other related formats, due to system complexity and mutability, in similar manner to the collapse of the “Quadraphonic Sound” phenomenon of several decades ago.

### U.S. PATENT DOCUMENTS

U.S. Pat. No. 6,504,934 January 2003 Kasai, et al Kasai, et al addressed localizing a “sound image”, without addressing cross-venue improvements.

U.S. Pat. No. 5,757,927 May 1998 Gerzon, et al Gerzon, et al addressed decoding without referencing the sound source.

U.S. Pat. No. 5,666,424 September 1997 Fosgate, et al Fosgate, et al presented a finite surround concept, without any referencing.

### SUMMARY OF THE INVENTION

Sound Space Replication is a referenced audio quality optimization and management system. Sound Space Replication addresses audio systems with a plurality of channels, but could be used for single channel (monaural) optimization, if desired. Sound Space Replication begins by volumetrically mapping the acoustic sound space topology of the audio mix-down or other final-stage audio creation (primary) venue sound system either just before or just after the program material's final creative activity, thus providing an in situ data representation of the acoustic sound space definition of that final-stage audio system. Prior to playback, the acoustic sound space topology of the subsequent playback (secondary) venue sound system is then volumetrically mapped in a manner congruent with the primary mapping method to create an in situ data representation of the acoustic sound space definition of that secondary system. The mapped secondary data is then compared with the mapped primary data, and any discrepancies between the two sets of data are identified and correlated. After the data comparison is completed, corrections and adjustments are electronically created and applied to the secondary system. Via this referenced correlation and correction process, the sound space of the secondary venue audio system is made objectively and measurably congruent to the sound space of the primary venue audio system within the specific capabilities of the secondary venue audio system and its environment.

### OBJECTS OF THE INVENTION

It is an object of the invention to provide a method for the mapping, storing and retrieval of volumetric acoustic sound space topology data as related to the output characteristics of a primary multi-channel audio system in its spatial environment.

It is another object of the invention to include and utilize height information within the volumetric acoustic sound space topology map to facilitate a precise vertical (up-down) placement and positioning of apparent sound sources within the volumetric acoustic sound space of a multi-channel audio system.

It is another object of the invention to include and utilize lateral information within the volumetric acoustic sound space topology map to facilitate a precise horizontal (left-right) placement and positioning of apparent sound sources within the volumetric acoustic sound space of a multi-channel audio system.

It is another object of the invention to provide transverse information within the volumetric acoustic sound space topology map to facilitate a precise “front-back” placement and positioning of apparent sound sources within the volumetric acoustic sound space of a multi-channel audio system.

It is another object of the invention to provide base-reference positioning information within the volumetric acoustic sound space topology map to facilitate a precise placement and positioning of the data acquisition (hence, “sweet-spot” listening) location within the volumetric acoustic sound space of a multi-channel audio system.

It is an object of the invention to provide a method for the mapping, storing and retrieval of volumetric acoustic sound space topology data as related to the output characteristics of a secondary multi-channel audio system in its spatial environment.

It is another object of the invention to compare and correlate the primary and secondary mapped volumetric acoustic sound space topology data.

It is another object of the invention to create electronic corrections files derived from the correlated mapped volumetric acoustic sound space topology data.

It is another object of the invention to provide congruent volumetric acoustic sound space replication within the secondary audio system sound space via electronic corrections that are referenced to the primary mapped volumetric sound space topological data.

It is another object of the invention to detect absent secondary audio channels via mapped and referenced sound space topological data.

It is another object of the invention to provide automatic phantom channel replacement if a secondary channel is detected as absent via mapped and referenced sound space topological data.

It is another object of the invention to provide secondary audio system spatial repositioning (virtual speaker relocation) as referenced to mapped sound space topological data.

It is another object of the invention to provide electronic reporting of acoustic and/or electronic related errors, discrepancies and/or other problems within the secondary system via mapped and referenced sound space topological data.

It is another object of the invention to provide sound system correlation and optimization, independent of the specific embodiment of the secondary system and its venue, via mapped and referenced sound space topological data.

It is another object of the invention to provide non-spatial (ie monaural), referenced sound system optimization, if desired.

It is another object of the invention to provide “actual” (program material specific), as well as “generic” (ie. engineer ideal) and “designer” (individually preferred) mapped sound space topological data as possible primary system data choices for the data comparison, corrections and optimizations.

It is another object of the invention to provide quantified/graded qualitative adjustment results reporting based on comparative data created after corrections and/or adjustments have been made to the secondary system, and the secondary system has been re-mapped.

It is another object of the invention to provide, if desired, quantified/graded reporting-only of the secondary system's mapped sound space topological data status without any adjustments having been made or having been intended to be made to the secondary system.

It is another object of the invention to utilize standardized corrections data for identically manufactured spaces (ie identical automobile model types, or identically built theaters, etc.).

It is another object of the invention to infer and transfer the originally mapped listening location (“sweet spot”) in a secondary venue to a user specified location within that secondary venue.

It is another object of the invention to provide multiple discrete listening locations (“sweet spots”) within a secondary venue.

### DESCRIPTION OF THE PREFERRED EMBODIMENT

Reference will now be made in detail to the currently preferred embodiment of the invention. While the invention will be made in conjunction with the preferred embodiment, it will be understood that it is not intended to limit the invention to this embodiment. On the contrary, the invention is intended to cover alternatives, modifications and equivalents, which may be included within the spirit and scope of the invention as defined by the appended claims.

The volumetric acoustic sound space topology of a primary (ie mix-down, mastering, encoding or other final-stage audio program material creation process) venue is mapped and stored with a system which includes a calibrated, directionally coherent transducer array, data storage apparatus and data processing software in close associative manner with a B-format based process. The mapping in the primary venue is intended to occur just prior to or just after an audio program material's final-stage audio creation event. During the mapping process, the sound system in the primary venue is delivered suites of diagnostically defining test signals. These signal suites include, but need not be limited to, acoustic pink noise, pulsed, frequency sweep, and phase delineating, as well as suites of FM chirps, M-sequence, and sequential triangulation bursts. The signal suites are sequentially emitted from each channel and each group of channels while the mapping apparatus is capturing data, thus providing both system response reference, and bistatic target detection and discrimination data of the sound system venue at the time of the final-stage audio creation event. The entire quantified spatial matrix reference data can then be time-stamped and stored in association with the final-stage audio program material from the primary venue.

NB: No attempt to perform adjustments to any part of the primary audio system is made or implied. The assumption is made that the director/sound designer approve of and prefer their program material as they hear it in the primary venue, and that they would wish their audiences to hear the program material as close as possible to the manner as presented within the primary venue's audio system sound space.

Prior to playback, the secondary (theatrical/consumer) venue's volumetric acoustic sound space topology is mapped and stored with the same, or pragmatically similar and understood, apparatus as used to create the mapped primary venue data. The same, or pragmatically similar and understood, suites of test signals are delivered to the secondary venue audio system with either the same or functionally and/or pragmatically similar and understood, calibrated, directionally coherent transducer array, storage apparatus and processing software.

The mapped data of both the primary and secondary venues is then correlated and compared. Discrepancies between the sets of data are articulated as difference files. Correction/adjustment files are then created as compensation for any detected deviations in the secondary system data from the referenced primary system data. The type and amount of correction, typically, but not exclusively, calculated as inverse deviation quanta, is applied to the secondary system.

To enable the secondary system correction process, each channel in the secondary audio system includes a broadly based independent array of active wave shaping capable software and apparatus. The corrections address artifacts which may result from such sources as, but not limited to, speaker type, speaker cross-over, speaker placement, room resonance, amplifier non-linearities, phase errors, spatial reflectances, etc. In the currently preferred embodiment, the secondary system's adjustments produce 1/24 octave curves, including, but not limited to, Butterworth, Bessel, and Linkwitz-Riley, as well as high pass, low pass, shelving, parametric and graphic style adjustments with variable Q as filter components of basic curve shaping, to allow the secondary system's sound space to be made congruent with the mapped primary audio system's sound space. The secondary system adjustment capability also provides signal adjustments for pre-crossover, crossover, box EQ, horn EQ, post-crossover artifacting, etc., as well as providing signal delays and clip avoidance as needed. Nominal system sound pressure levels are addressed as needed. Additionally, sound pressure level related adjustments as perceptually indicated by Fletcher-Munson curve effects are selectively included as indicated by usage.

As an example, during the Sound Space Replication process, spatially identifying speaker location data, to include transverse, lateral, height and distance sound source location data, is extracted, correlated and compared from both the primary and secondary venue's mapped data. After comparing the primary audio system's speaker locations within the primary venue with the secondary audio system's speaker locations within the secondary venue, the apparent speaker locations (spatial origination points or virtual speaker locations) within the secondary system are then virtually repositioned and corrected to be congruent with the primary venue's speaker locations, as needed, via corrections software.

After the corrections process is complete, a re-mapping may be performed to the secondary venue sound system to determine a quantification of the degree of post-corrections accuracy that the secondary audio system sound space is delivering, as referenced to the primary audio system sound space. The post-corrections secondary venue data is referenced and compared with the primary venue data to create a reportable amount of relative exactness of congruence that the secondary venue sound space has achieved.

It is noted that Sound Space Replication is a feature to and independent of the remaining specific embodiment of a secondary venue audio system.

Further, corrections data may be standardized and applied to identical secondary audio systems that are installed in identically manufactured venues (ie. identical automobile model types, identically built theaters, etc). This process may be viewed as a potentially less precise, but industrially acceptable practice when compared with the above-described method.

In some instances, it may be desirable to shift the ideal listening location from the original position of the mapping transducers to a preferred location in the secondary venue. This process may be accomplished by shifting the base reference (“W” in B-Format terminology) and other resultant cascading adjustments of the mapped corrections data to achieve the preferred location results.

To improve functional accessibility, the secondary audio system is also networkable, so as to provide supervisory system control and monitoring via remotely accessed status reporting.

In actual commercial practice, a set of preferred primary data, which is other than the actual mapped primary data associated with a particular program material, may be chosen and provided for comparison and corrections to a secondary venue sound system. This preferred data could be “designer” preferred (ie. famous person/star endorsed), or “generic/engineer ideal” preferred data, etc.

Commercial and consumer applications of Sound Space Replication include, but are not limited to, CD, DVD, DVDA, SACD, streamed media, computer sound cards and systems, video games, amplifiers, receivers, preamplifiers, cinema, digital cinema, live sound reinforcement systems, audio/video teleconferencing and other remote-style applications, as well as future audio system situations.

In some specific instances of practice, the user of Sound Space Replication may prefer to only obtain system status, without any intent or attempt for corrections. Comparative as well as stand-alone system status reporting only is also accommodated within the process.

Delivery of the mapped primary venue data may be accomplished in any able and agreed method, including, but not limited to, embedded ROM, networked storage, media metadata, or future delivery carrier.

Via this referenced correlation and correction process, the sound space of the secondary venue audio system is made objectively and measurably congruent to the sound space of the primary venue audio system within the specific capabilities of the secondary venue audio system and its environment.

In this manner, audio program material presented (and, arguably, heard) in the secondary venue is both directly referenced to and made to be more identical to that same audio program material as presented to and approved by the program material's creator(s) in the primary venue.

Thus the reader of this description will understand that Sound Space Replication provides an automated audio system optimization, which is directly referenced to specific program material in its creation venue.

In the foregoing specification, the invention has been described with reference to a specific embodiment. It will, however, be evident that various modifications and changes may be made without departing from the broader spirit and scope of the invention as set forth in the appended claims and their legal equivalents. Accordingly, this specification is to be regarded in an illustrative rather than a restrictive sense.

What is claimed is:

1. A method for providing sound space replication, the method comprising:
a) acquiring and storing data representations of acoustic emanations from a primary audio system in situ,
b) acquiring and storing data representations of acoustic emanations from a secondary audio system in situ,
c) referencing and comparing said primary audio system data and said secondary audio system data,
d) creating corrections data from said comparison, and
e) applying said corrections data to said secondary audio system,
whereby said secondary audio system sound space is made congruent to said primary audio system sound space, and
whereby a listener of audio program material in said secondary audio system sound space is provided said audio program material in a manner that is congruent to said listener of said audio program material in said primary audio system sound space.

2. The method as recited in claim 1 further including spatially identified speaker location sound source data is extracted,
whereby said speaker location sound source data within a venue is electronically reportable.

3. The method as recited in claim 1 wherein virtual speaker locations in said secondary audio system sound space are positioned to be congruent to speaker locations in said primary audio system sound space, the method comprising:
a) extracting sound source location data of said primary audio system and sound source location data of said secondary audio system,
b) referencing and comparing said primary sound source location data and said secondary sound source location data,
c) creating virtual speaker positioning data from said comparison, and
f) applying said virtual speaker positioning data to said secondary audio system,
whereby said secondary audio system sound space virtual speaker locations are made congruent to said primary audio system speaker locations, and
whereby replicating said primary audio system speaker locations via virtual speaker positioning within said secondary audio system sound space, and
whereby a listener of audio program material in said secondary audio system sound space is provided said audio program material with virtual speaker locations that have been made congruent to said listener of said program material in said primary audio system sound space with said primary speaker locations.

4. The method as recited in claim 1 wherein if emanations from a channel in said secondary audio system are detected as absent via said comparison, phantom program material is provided via said corrections,
whereby program material from said absent secondary audio system channel is provided as referenced to said primary audio system.

5. The method as recited in claim 1 wherein misconfigured audio channels within said secondary audio system are identified, and configured via said corrections as referenced to said primary audio system.

6. The method as recited in claim 1 wherein referenced non-spatial secondary audio system optimization is provided within monaural systems.

7. The method as recited in claim 1, further including errors, discrepancies and other referenced issues detected within said secondary system by said comparison are electronically reportable.

8. The method as recited in claim 1, further including quantified, graded reporting of the resultant qualitative accuracy of said corrections applied to said secondary system is provided, the method comprising:
a) acquiring and storing data representations of acoustic emanations from said secondary audio system in situ after said corrections have been applied to said secondary audio system,
b) comparing said primary audio system data with said corrected secondary audio system data,
c) electronically reporting the degree of comparative congruence of said corrected secondary system data to said primary system data,
whereby said corrected secondary system sound space congruence to said primary audio system sound space is made electronically reportable, and
whereby a qualitative degree of comparative sound space accuracy may be reported as representative of said corrected secondary audio system.

9. The comparison method as recited in claim 1, further including said primary audio system data being accessible from a plurality of storage locations.

10. The method as recited in claim 1, further including a novel embodiment of the apparatus used for acquiring and storing data representations of acoustic emanations, which has understood similarities and congruence to the apparatus used for said acquiring and storing data representations of acoustic emanations from said primary audio system sound space, is used for acquiring and storing data representations of acoustic emanations from said secondary audio system sound space.

11. The method as recited in claim 1 wherein there exists networkable, supervisory system control and monitoring via remotely accessed status reporting.

12. The method as recited in claim 1 wherein said comparison data is used for grading and reporting purposes only, and no corrections need be created or applied to said secondary audio system sound space.

13. The method as recited in claim 1, further including transferring said secondary audio system sound space intended listening location from said location to a specified location within said secondary venue via said corrections data.

14. The method as recited in claim 1, further including creating pluralities of intended listening locations within said secondary audio system sound space via said corrections data.

15. The method as recited in claim 1, further including manufactured venue instances where said secondary audio system sound space data and said corrections data are standardized and applied to audio systems of a plurality of subsequent secondary venues, which have been manufactured identically to said manufactured venue.

16. The method as recited in claim 1, further including preferred primary data, which is other than said primary audio system sound space data, used for said comparison.

17. The method as recited in claim 1 wherein the sound space replication process is independent of the remaining specific embodiment of said secondary audio system.

18. The method as recited in claim 1 wherein any number of corrections that is less than all said corrections may be user articulated and implemented.

19. A method for providing sound space replication, the method comprising:
a) topological data mapping and storing volumetric acoustic sound space emanations from a primary audio system in situ,
b) topological data mapping and storing volumetric acoustic sound space emanations from a secondary audio system in situ,
c) referencing and comparing said primary audio system mapped data and said secondary audio system mapped data,
d) creating corrections data from said comparison, and
e) applying said corrections data to said secondary audio system,
whereby said secondary audio system sound space is made congruent to said primary audio system sound space, and
whereby a listener of audio program material in said secondary audio system sound space is provided said audio program material in a manner that is congruent to said listener of said audio program material in said primary audio system sound space.

20. A method for creating referenced adjustments to a sound system, the method comprising:
a) data mapping and storing acoustic emanations from a primary audio system in situ,
b) data mapping and storing acoustic emanations from a secondary audio system in situ,
c) referencing and comparing said primary audio system mapped data and said secondary audio system mapped data,
d) creating adjustment data from said comparison, and
e) applying said adjustment data to said secondary audio system,
whereby said secondary audio system is adjusted as referenced to said primary audio system, and
whereby a listener of audio program material in said secondary audio system venue is provided said audio program material in a manner that has been adjusted as referenced to said audio program material in said primary audio system venue.
